(19) United States
(12) Patent Application Publication
(10) Pub. No.: US 2024/0428969 A1
(43) Pub. Date: Dec. 26, 2024

(54) COIL DEVICE

(71) Applicant: TDK CORPORATION, Tokyo (JP)

(72) Inventors: Atsushi Shoji, Tokyo (JP); Masaru Kumagai, Tokyo (JP)

(73) Assignee: TDK CORPORATION, Tokyo (JP)

(21) Appl. No.: 18/743,207

(22) Filed: Jun. 14, 2024

(30) Foreign Application Priority Data
Jun. 20, 2023 (JP) 2023-101175

(51) Int. Cl. H01F 5/02; H01F 5/04; H01F 27/02; H01F 27/28; H01F 27/30

(52) U.S. Cl. CPC H01F 5/02; H01F 5/04; H01F 27/02; H01F 27/2828; H01F 27/306

(57) ABSTRACT

A coil device includes a first tubular part 41, a first bobbin 40 including a terminal block 42 provided with a terminal 30b, a first wound part 11 placed on the first tubular part 41, a first wire 10 pulled out from the first wound part 11 and connected to the terminal 30b, a second tubular part 51 accommodating the first tubular part 41, a second tubular part 21 placed on the second tubular part 51, and a second wire 20 including a second part 22b pulled out from the second wound part 21 to the opposite side to the first lead-out part 12b. An intermediate part has a corrugation on the outer surface.

### TECHNICAL FIELD

The present invention relates to a coil device.

### BACKGROUND

As an example, used for a transformer, the coil device shown in Patent document 1 is known. The coil device of Patent document 1 includes a bobbin, a core installed to the bobbin, and a first wire and a second wire wound around the bobbin. The bobbin includes a tubular part provided with a first wound part of the first wire and a second wound part of the second wire, a first terminal block formed on one end in an axial direction of the tubular part and provided with a first terminal; and a second terminal block formed on the other end of the axial direction of the tubular part and provided with a second terminal. The first terminal is connected to a first lead-out part of the first wire, and the second terminal is connected to a second lead-out part of the second wire. At the inside of the tubular part, an I-shaped core is inserted, and at both ends in the axial direction of the I-shaped core, a U-shaped core arranged outside of the tubular part is connected.

In a coil device shown in Patent Document 1, the first wound part and the second wound part are arranged along an axial direction of the bobbin. Thus, a length of a bobbin in the axial direction inevitably becomes long to secure installation spaces for the first wound part and the second wound part; hence, it is difficult to make the coil device compact. Also, the coil device of Patent Document 1 is equipped with a plurality of electric conductive members such as a first wire and a second wire. Therefore, if the coil device is to be made compact, a distance between the electric conductive members becomes short, and a voltage resistance may decline.
[Patent Document 1] JP Patent Application Laid Open No. H09-186024

### SUMMARY

The present disclosure is achieved in view of such circumstances, and the object is to provide a compact coil device with excellent voltage resistance reliability.

In order to achieve the above-mentioned object, the coil device according to the present invention includes
a first bobbin including a first tubular part and a terminal block provided with a terminal;
a first wire including a first wound part provided on the first tubular part, and a first lead-out part pulled out from the first wound part to connect with the terminal;
a second bobbin including a second tubular part accommodating the first tubular part, and an intermediate part positioned between the second tubular part and the terminal block; and
a second wire including a second wound part provided on the second tubular part, and a second lead-out part pulled out from the second wound part to an opposite side of the first lead out part; wherein
the intermediate part has a corrugation on an outer surface of the intermediate part.

The coil device according to the present disclosure includes the first bobbin and the second bobbin, and the first tubular part is accommodated inside the second tubular part. That is, the first tubular part and the second tubular part are arranged in an overlapping manner; thus, compared to a conventional technology, the length of the coil device in the axial direction of the first tubular part (the second tubular part) becomes shorter, hence, the coil device can be more compact. Also, in the coil device according to the present disclosure, the intermediate part is positioned between the second tubular part and the terminal block of the first bobbin, and a corrugation is formed on the outer surface of the intermediate part. Therefore, depending on the level of corrugation, a creepage distance between the second wound part provided to the second tubular part and the terminal (the first lead-out part connected to the terminal) provided on the terminal block are extended, and an insulation property between the second wound part and the terminal is secured. Therefore, according to the present disclosure, it is possible to make the coil device compact without decreasing the voltage resistance between the second wound part and the terminal, and it is also possible to achieve a compact coil device with excellent voltage resistance reliability.

The corrugation on the intermediate part may be extended in a direction perpendicular to the axial direction of the second tubular part. In this case, depending on the repeating numbers of corrugations, the creepage distance between the second wound wire provided on the second tubular part and the terminal provided on the terminal block can be extended.

The intermediate part may include a base part and a side part extending vertically from the base part, and the corrugation is formed at least on the side part. In this case, the creepage distance between the second wound part provided on the second tubular part and the terminal provided on the terminal block is extended to the side part, and a current path which runs through between the second wound part and the terminal via the side part can be prevented from forming.

The intermediate part may include a base part and a side part extending vertically from the base part, and the corrugation may be formed at least on the base part. In this case, the creepage distance between the second wound part provided on the second tubular part and the terminal provided on the terminal block is extended to the base part, and a current path which runs through between the second wound part and the terminal via the base part can be prevented from forming.

The intermediate part may include a base part and a side part extending vertically from the base part, and the corrugation is formed in a continuous manner from the base part to the side part. In this case, the creepage distance between the second wound part provided on the second tubular part and the terminal provided on the terminal block is extended to the base part and the side part, and a current path which runs through between the second wound part and the terminal via the base part and the side part can be prevented from forming.

The coil device may further include a cover installed on a bottom of the second bobbin and arranged between the second wound part and the second lead-out part; wherein the cover is formed with a cover corrugation, and the cover corrugation on the cover is at a position corresponding to the corrugation of the intermediate part. In this case, the creepage distance between the second lead-out part extending over the cover and the terminal provided on the terminal block is extended according to the level of the corrugation on the cover. Hence, a current path which runs through between the second wound part and the terminal via the cover can be prevented from forming. Thereby, the insulation property between these can be ensured.

The cover corrugation may engage with the corrugation of the intermediate part. In this case, a space distance between the second wound part provided on the second tubular part and the terminal provided on the terminal block extends according to the level of corrugation of the intermediate part and the level of the cover corrugation. Thus, a current path between the second wound part and the terminal via the space between the second bobbin and the cover can be prevented from forming; thereby, the insulation property between the second wound part and the terminal can be ensured.

The cover corrugation may be formed on an outer surface and an inner surface of the cover. In this case, the creepage distance between the second lead-out part extending over the cover and the terminal provided on the terminal block can be extended due to the cover corrugation formed on the outer surface of the cover. Additionally, the space distance between the second wound wire provided on the second tubular part and the terminal provided on the terminal block can be extended due to the cover corrugation formed on the inner surface of the cover.

### BRIEF DESCRIPTION OF DRAWINGS

FIG. 1A is a perspective view of a coil device according to one embodiment of the present disclosure.

FIG. 1B is a perspective view of the coil device of FIG. 1A from a different angle.

FIG. 2 is an exploded perspective view of the coil device shown in FIG. 1A.

FIG. 3 is a cross sectional view of the coil device shown in FIG. 1A along a line III-III.

FIG. 4 is a perspective view of a first bobbin shown in FIG. 2.

FIG. 5A is a perspective view of a second bobbin shown in FIG. 2.

FIG. 5B is a perspective diagram view of the second bobbin shown in FIG. 5A from a different angle.

FIG. 5C is a bottom view of the second bobbin shown in FIG. 5A.

FIG. 6 is a bottom view of the first bobbin to which a first wire is wound and the second bobbin to which a second wire is wound.

FIG. 7 is a perspective view of a first cover shown in FIG. 2.

FIG. 8 is a side view of the coil device shown in FIG. 1A.

FIG. 9 is a bottom view of the second bobbin to which the first cover is installed.

FIG. 10 is a perspective view of a second cover shown in FIG. 2.

### DETAILED DESCRIPTION

In below, embodiments of the present disclosure are described based on the figures. Note that, contexts shown in the figures are simply schematic and exemplary representations of the present disclosure; hence, appearances and dimensional ratios may not necessarily be exactly the same as the actual device. Also, the present disclosure is not limited to the below described embodiments.

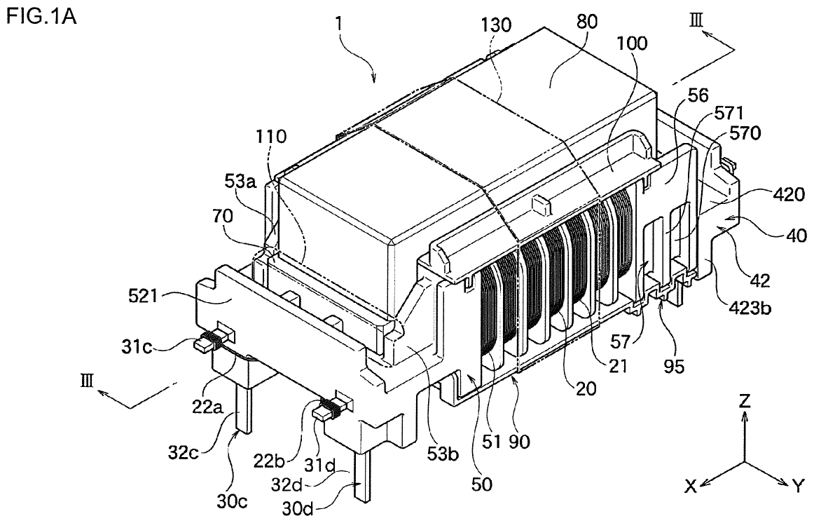

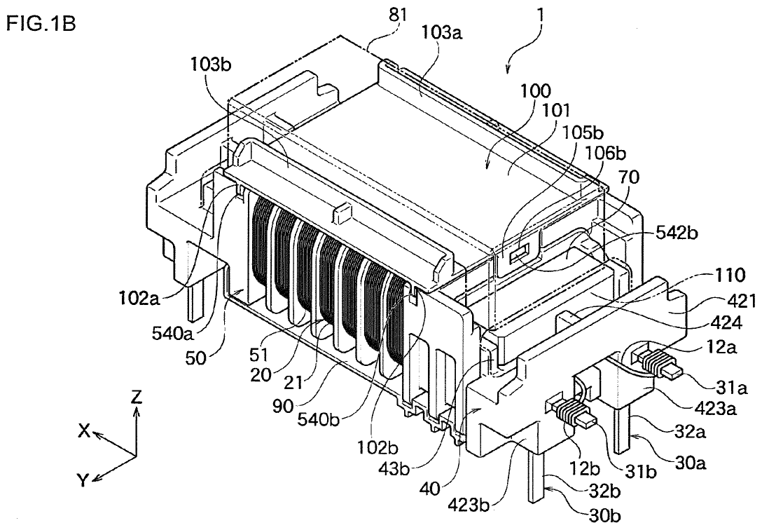

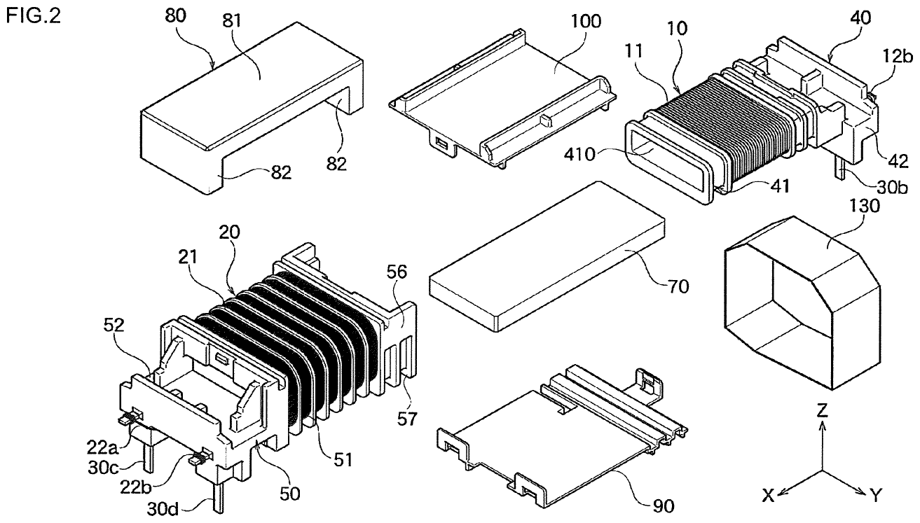

A coil device 1 according to an embodiment of the present disclosure shown in FIG. 1A and FIG. 1B functions, for example, as a transformer (a step-up transformer, etc.). As shown in FIG. 2, the coil device 1 includes a first wire 10, a second wire 20, a first bobbin 40, and a second bobbin 50. The coil device 1 further includes terminals 30a to 30d (FIG. 1A and FIG. 1B), a first core 70, a second core 80, a first cover 90, a second cover 100, and a tape 130; and at least one of these may not be included in the coil device 1.

In FIG. 2 and so on, an X-axis is an axis corresponding to a longitudinal direction of the first core 70. Also, a Y-axis is an axis corresponding to a short direction of the first core 70. Further, a Z-axis is an axis perpendicular to the X-axis and the Y-axis. In below, a positive direction of Z-axis is referred to as “upward”, and a negative direction of the Z-axis is referred to as “downward”. Also, for each of the X-axis, the Y-axis, and the Z-axis, a direction towards a center of the coil device 1 is referred to as “inner side” and a direction away from the center of the coil device 1 is referred to as “outer side”.

A length along the X-axis of the coil device 1 is 30 to 50 mm, a length along the Y-axis of the coil device 1 is 10 to 20 mm, and a length along the Z-axis of the coil device 1 is 10 to 25 mm. Note that, a size of the coil device 1 is not limited thereto.

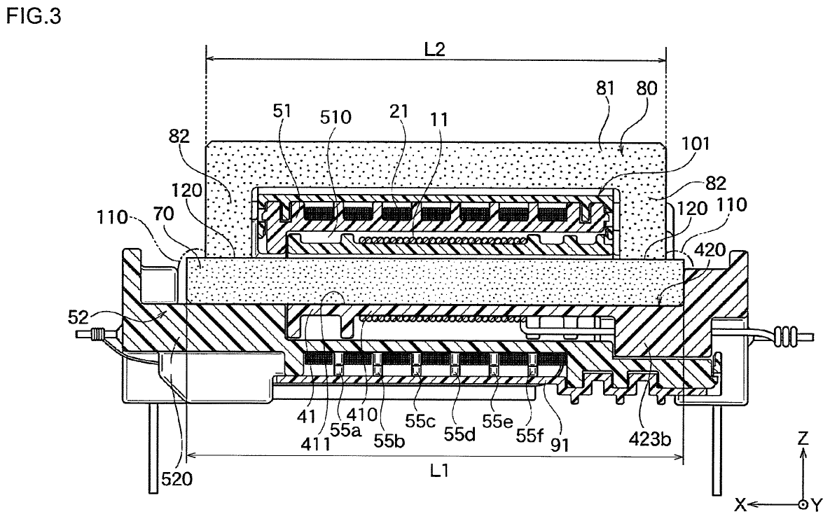

The first wire 10 includes a first wound part 11 wound in a coil form, and first lead-out parts 12a and 12b which are pulled out from the first wound part 11 (FIG. 1B). The second wire 20 includes a second wound wire 21 wound in a coil form, and second lead-out parts 22a and 22b which are pulled out from the second wound part 21 to an opposite side of the first lead-out parts 12a and 12b. As shown in FIG. 3, the first wound part 11 and at least part of the second wound part 21 are facing to each other along the radial direction thereof. The first wire 10 configures a primary wire and the second wire 20 configures a secondary wire, however, this relation may be reversed.

The first wire 10 and the second wire 20 are respectively configured of a solid wire, however, a pair wire, or a litz wire may be used. The first wire 10 and the second wire 20 may respectively be, for example, an insulation coated wire of which a core wire made of metals such as copper etc., is coated by an insulation coating. A diameter of each of the first wire 10 and the second wire 20 is not particularly limited, and it may be 0.1 to 1.0 mm. A diameter of the first wire 10 is different from a diameter of the second wire 20, however, these diameters may be the same.

Although it is not particularly limited, the first wound part 11 is formed in one layer along the radial direction thereof. The number of layers in the first wound part 11 may be a plurality of layers. The second wound part 21 has five layers along the radial direction thereof, although it is not particularly limited to this.

As shown FIG. 1A and FIG. 1B, the terminals 30a to 30d are L-shaped, and have wire joint parts 31a to 31d and external connection parts 32a to 32d. The terminals 30a to 30d are formed by conductive materials such as metals. A first lead-out part 12a is connected to the wire joint part 31a, and a first lead-out part 12b is connected to the wire joint part 31b. Also, a second lead-out part 22a is connected to the wire joint part 31c, and a second lead-out part 22b is connected to the wire joint part 31d. The external connection parts 32a to 32d are portions connecting to an external substrate (not shown in the figure). The coil device 1 is, for example, mounted on the external substrate so that the bottom of the second bobbin 50 is parallel to the external substrate.

As shown in FIG. 2, the first core 70 is an I-shaped core of a rectangular parallelepiped shape. The second core 80 is a U-shaped core. The second core 80 has a main body part 81 and leg parts 82 which extend from both ends in the X-axis direction of the main body part 81 such that the leg parts 82 are perpendicular to the main body part 81. The first core 70 and the second core 80 are magnetic materials, and these may be configured of a ferrite composition, a metal composition, a composite composition made of these and a resin, or so. The first core 70 and the second core 80 may be made of a sintered body of a metal magnetic material.

The first core 70 is installed to the first bobbin 40, and the second core 80 is installed to the second bobbin 50. As shown in FIG. 3, the second core 80 is combined with the first core 70. Two joining parts 120 are formed between the first core 70 and the second core 80. One of the joining parts 120 joins one of the leg parts 82 and the first core 70. The other one of the joining parts 120 joins the other leg parts 82 and the first core 70. By connecting the first core 70 and the second core 80, a ring-shape core is formed; thereby, the magnetic properties of the coil device 1 can be improved.

A length L1 along the X-axis of the first core 70 is not particularly limited, and it may be longer than a length L2 along the X-axis of the second core 80. Thus, the both ends of the first core 70 in the X-axis direction protrude to outer side than both ends of the second core 80 in the X-axis direction. A width of protrusion of the first core 70 is, for example, 1 mm or longer. In the case of L1>L2, even if the position of the joining part 120 shifts in the X-axis direction as the positions of the first core 70 or/and the second core 80 shift in X-axis direction, an area of the joining part 120 (the cross-section area of a magnetic path of a ring form core at the joining part 120) becomes less likely to fluctuate.

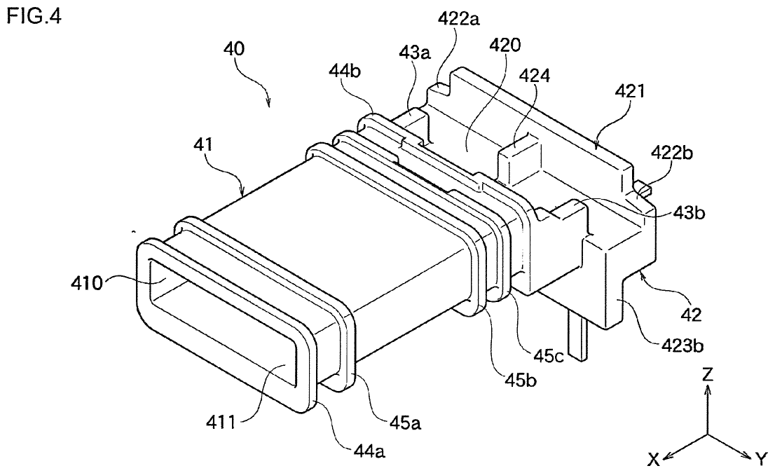

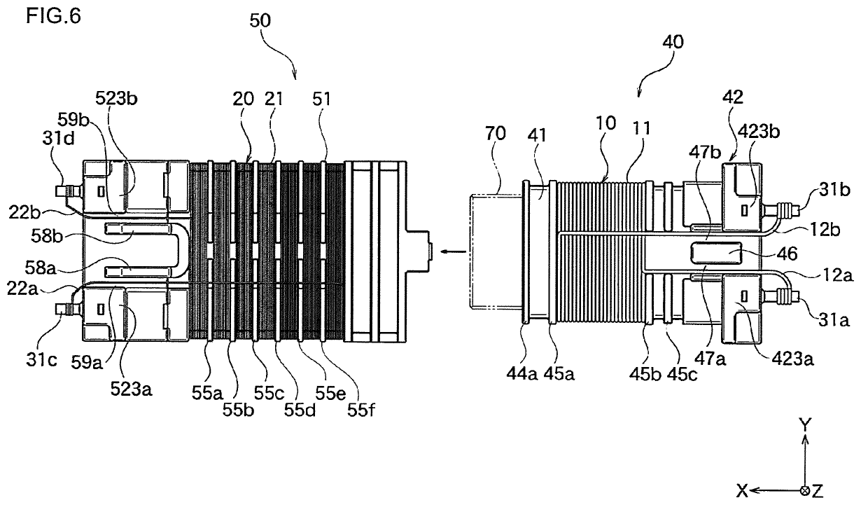

As shown in FIG. 4, the first bobbin 40 includes a first tubular part 41, and a first terminal block 42 which is provided with the terminals 30a and 30b (FIG. 1B). The first bobbin 40 further includes side wall parts 43a and 43b, flange parts 44a and 44b, partition parts 45a to 45c, a guide protrusion 46 (FIG. 6), and lead-out paths 47a and 47b; however, at least one of these may not be included in the first bobbin 40. The first bobbin 40 is configured of, for example, plastics such as PPS, PET, PBT, LCP, etc., and other insulation members (preferably a material with a heat resistance), etc.

The first tubular part 41 is a cylindrical body, and includes a through hole 410 and a core installation face 411. An axial direction of the tubular part 41 corresponds to the X-axis direction. A transverse cross-section shape of the first tubular part 41 is not particularly limited, and it may be a rectangular shape. As shown in FIG. 2, an outer circumference of the first tubular part 41 is wrapped with the first wire 10 to form the first wound part 11.

As shown in FIG. 4, the through hole 410 extends along the axial direction of the first tubular part 41. At the inside of the first tubular part 41, at least part of the first core 70 (FIG. 2) is inserted (housed) (see FIG. 6). The core installation face 411 is a flat surface parallel to the XY plane, and the core installation face 411 configures the base part of the inner wall surface of the through hole 410. At the core installation face 411, the first core 70 (FIG. 2) is placed.

The flange part 44a is formed on one end of the first tubular part 41 in the X-axis direction, and the flange part 44b is formed on the other end of the first tubular part 41 in the X-axis direction. The flange parts 44a and 44b project to the outside in the radial direction from the outer circumference surface of the first tubular part 41, and the flange parts 44a and 44b extend along the circumference direction of the first tubular part 41.

The partition parts 45a to 45c are formed between the flange part 44a and the flange part 44b. The partition parts 45a to 45c project to the outside in the radial direction from the outer circumference surface of the first tubular part 41. The partition part 45a is formed continuously along the circumference direction of the first tubular part 41. As shown in FIG. 6, the partition parts 45b and 45c extend along the circumference direction of the first tubular part 41; however, the partition parts 45b and 45c are formed discontinuously on the first tubular part 41.

The partition parts 45a to 45c separate the outer circumference surface of the first tubular part 41 into a plurality of sections. The first wound part 11 is formed at the section between the partition part 45a and the partition part 45b. The first wound part 11 is neither formed at the section between the partition part 45b and the partition part 45c nor at the section between the flange part 44a and the partition part 45a. Thus, an insulation distance between the first core projecting out from the both ends of the first tubular part 41 in the X-axis direction (FIG. 3) and the first wound part can be secured. If needed, the first wound part 11 may be formed to other sections.

As shown in FIG. 4, the first terminal block 42 is formed at the end part of the first tubular part 41 in the X-axis direction. The first terminal block 42 includes, for example, a first main body 420, a raised insulation part 421, notches 422a and 422b, lower projection parts 423a and 423b, and a stopper 424.

The main body part 420 is a flush with the core installation face 411. A length of the main body part 420 along the Y-axis direction is longer than a length of the first tubular part 41 along the Y-axis direction. The raised insulation part 421 is formed at the outer end part of the main body part 420 in the X-axis direction, and the raised insulation part 421 projects upwards from the upper surface of the main body part 420 along the Z-axis direction. As shown in FIG. 1B, the raised insulation part 421 is positioned, in the X-axis direction, between the wire joint parts 31a and 31b and the first core 70. The raised insulation part 421 separates the first core 70 and the wire joint parts 31a and 31b; thereby, the insulation distance (the creepage distance and the space distance) between the wire joint parts 31a and 31b and the first core 70 can be extended.

The raised insulation part 421 is formed at upper side than the wire joint parts 31a and 31b. A height of the raised insulation part 421 may be the same as or thicker than a thickness of the first core 70 in the Z-axis direction. Also, the length of the raised insulation part 421 along the Y-axis may be the same as or longer than the length of the first core 70 along the Y-axis. Thereby, the insulation distance between the first core 70 and the wire joint parts 31a and 31b may be extended effectively.

As shown in FIG. 4, the notches 422a and 422b are formed on the upper part of the raised insulation part 421. The notches 422a and 422b are respectively formed at one end and the other end of the raised insulation part 421 in the Y-axis direction. The stopper 424 is formed at the center part of the main body part 420 in the Y-axis direction, and the stopper 424 projects upwards from the upper surface of the main body part 420. The stopper 424 projects from the inner surface of the raised insulation part 421 in the X-axis direction.

As shown in FIG. 1B, in regards with the X-axis direction, the stopper 424 is positioned between the raised insulation part 421 and the end of the first core in the X-axis direction. The stopper 424 contacts with the end part of the first core 70 in the X-axis direction, and the position in the X-axis direction of the first core 70 is determined. Note that, a plurality of stoppers 424 may be used.

As shown in FIG. 1B and FIG. 4, the lower projection parts 423a and 423b project downward from the bottom surface of the main body part 420. The lower projection parts 423a and 423b are spaced from each other along the Y-axis direction. The lower projection part 423a is provided with the external connection part 32a, and the lower projection part 423b is provided with the external connection part 32b.

The terminals 30a and 30b are spaced from each other along the Y-axis. The terminals 30a and 30b are integrally molded (insert molding) respectively with the lower projection parts 423a and 423b. Note that, the terminals 30a and 30b may be respectively inserted in the lower projection parts 423a and 423b. The wire joint part 31a projects out along the X-axis from the lower projection part 423a. The external connection part 32a projects downward from the lower projection part 423a. The wire joint part 31b projects out along the X-axis from the lower projection part 423b. The external connection part 32b projects downward from the lower projection part 423b.

As shown in FIG. 4, the side wall parts 43a and 43b are spaced from each other along the Y-axis. The side wall part 43a projects upward from the installation face 411 or the upper surface of the main body part 420. The side wall part 43b projects upward from the core installation face 411 or the upper surface of the main body part 420.

As shown in FIG. 1B, the end part of the first core 70 in the X-axis direction is arranged between the side wall part 43a and the side wall part 43b. The side wall parts 43a and 43b hold the end part of the first core 70 in the X-axis direction from both sides of the first core 70 in the Y-axis direction. The side wall parts 43a and 43b prevent the first core 70 from shifting its position in the Y-axis direction.

The end part of the first core 70 in the X-axis direction is connected to the side wall parts 43a and 43b using a resin 110. Also, the end part of the first core 70 in the X-axis direction is connected to the upper surface of the main body part 420 using the resin 110 at a position on outer side in the X-axis direction than a position of the joining part 120 (FIG. 3). The upper parts of the side wall parts 43a and 43b have notches to enhance the adhesive strength (adhered area) with the resin 110.

As shown in FIG. 6, the guide protrusion 46 protrudes downward from the bottom of the second bobbin 50. The guide protrusion 46 extends in a longitudinal shape along the X-axis. The lead-out paths 47a and 47b are formed along the guide protrusion 46, and extend along the X-axis direction. The first lead-out part 12a is pulled out along the lead-out path 47a from the first wound part 11 to the wire joint part 31a. Also, the first lead-out part 12b is pulled out along the lead-out path 47b from the first wound part 11 to the wire joint part 31b.

A part of the lead-out path 47a is formed between the guide protrusion 46 and the lower projection part 423a. By pulling out the first lead-out part 12a along the lead-out path 47a, the guide protrusion 46 and the lower projection part 423a can protect the first lead-out part 12a from external load. A part of the lead-out path 47b is formed between the guide protrusion 46 and the lower projection part 423b. By pulling out the first lead-out part 12b along the lead-out path 47b, the guide protrusion 46 and the lower projection part 423b can protect the first lead-out part 12b from external load.

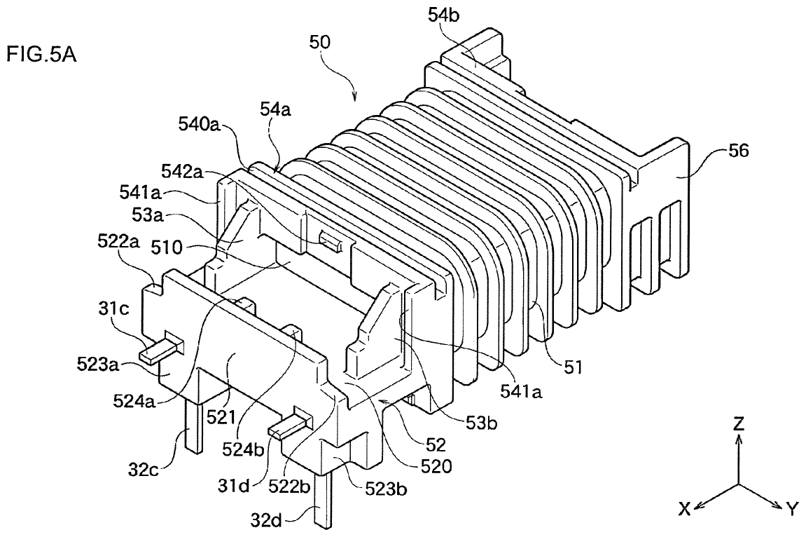

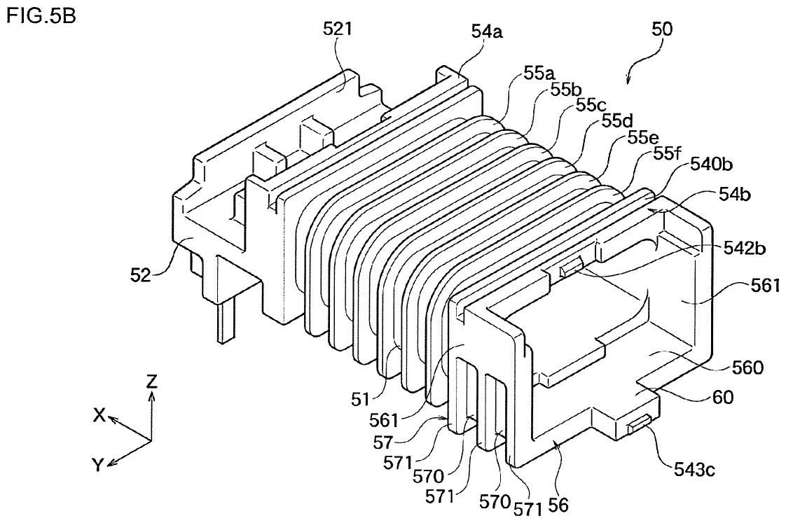

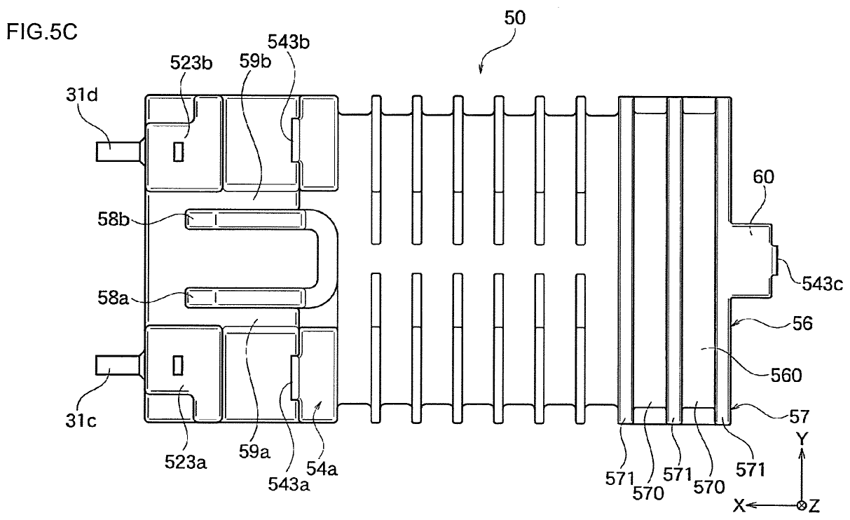

As shown in FIG. 5A to FIG. 5C, the second bobbin 50 includes a second tubular part 51, an intermediate part 56, and a corrugation 57. The second bobbin 50 further includes a second terminal block 52, side wall parts 53a and 53b, flange parts 54a and 54b, partition parts 55a to 55f, guide protrusions 58a and 58b, lead-out paths 59a and 59b, and a side projection part 60; however, at least one of these may not be included in the second bobbin 50. The second bobbin 50 is made of the same material used for the first bobbin 40; however, it may be made of a different material than that used for the first bobbin 40.

As shown in FIG. 5A, the second tubular part 51 is a cylindrical body, and includes a through hole 510. The through hole 510 extends along an axial direction of the second tubular part 51. The axial direction of the second tubular part 51 corresponds to the X-axis direction. A transverse cross-section shape of the second tubular part 51 is not particularly limited, and it may be a rectangular shape. As shown in FIG. 2, the second wire 20 is wound around an outer circumference surface of the second tubular part 51, and the second wound part 21 is formed around an outer circumference surface of the second tubular part 51. As shown in FIG. 3, the first tubular part 41, in which the first core 70 is inserted, is accommodated inside the through hole 510.

As shown in FIG. 5A, the flange part 54a is formed to one end in the X-axis direction of the second tubular part 51, and the flange part 54b is formed to the other end in the X-axis direction of the second tubular part 51. The flange parts 54a and 54b project out in a radial direction from the outer circumference face of the second tubular part 51. The flange part 54a, for example, includes an engaging groove 540a, a pair of flange side wall parts 541a, an engaging projection 542a, and engaging projections 543a and 543b (FIG. 5C).

The engaging groove 540a is formed on the upper end of the flange part 54a, and it extends from one end to the other end in the Y-axis direction of the flange part 54a. The engaging projection 542a is formed on an outer end surface of the flange part 54a, and the engaging projection 542a projects out along the X-axis. One of the pair of flange side wall parts 541a is formed on one side part in the Y-axis direction of the flange part 54a, and the other one of the pair of flange side wall parts 541a is formed on the other side part in the Y-axis direction of the flange part 54a. The pair of flange side wall parts 541a projects out along the X-axis.

As shown in FIG. 5C, the engaging projections 543a and 543b are formed at the lower end part of the flange part 54a. The engaging projection 543a projects out along the X-axis at one side of the flange part 54a in the Y-axis direction. The engaging projection 543b projects out along the X-axis at the other side of the flange part 54a in the Y-axis direction.

As shown in FIG. 5B, the flange part 54b, for example, includes an engaging groove 540b and an engaging projection 542b. The engaging groove 540b is formed on an upper end of the flange part 54b, and it extends from one end to the other end of the flange part 54b in the Y-axis direction. The engaging projection 542b is formed on the outer end face of the flange part 54b, and projects out along the X-axis.

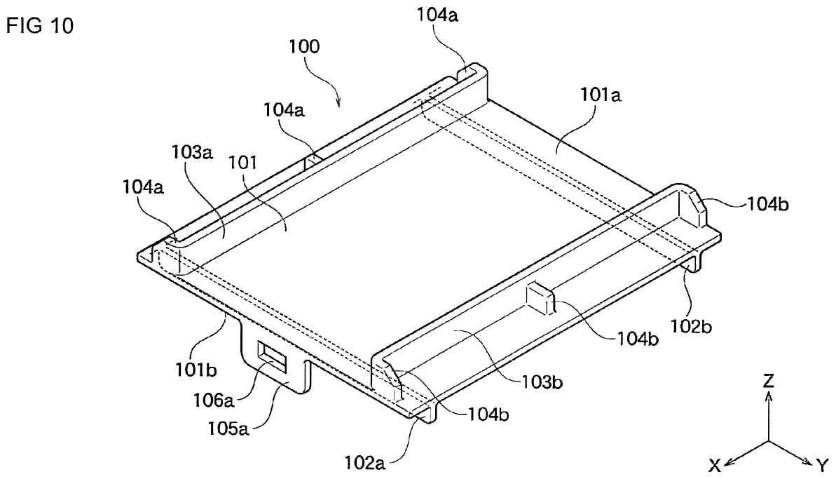

The engaging grooves 540a and 540b shown in FIG. 5A and FIG. 5B engage with engaging projections 102a and 102b of the second cover 100 shown in FIG. 10. Also, the engaging projections 542a and 542b shown in FIG. 5A and FIG. 5B engage with engaging holes 106a and 106b of the second cover 100 shown in FIG. 1B and FIG. 10.

As shown in FIG. 5B, the partition parts 55a to 55f are formed between the flange part 54a and the flange part 54b. The partition parts 55a to 55f project out in a radial direction from the outer circumference face of the second tubular part 51. As shown in FIG. 6, the partition parts 55a to 55c extend in a discontinuous manner along the circumference direction of the second tubular part 51.

The partition parts 55a to 55f separate the outer circumference face of the second tubular part 51 into a plurality of sections along the X-axis direction. By forming the partition parts 55a to 55f on the second tubular part 51, improper windings of the second wound part 21 (FIG. 2) formed on the second tubular part 51 can be prevented.

As shown in FIG. 5A, the second terminal block 52 is formed at the end part of the second tubular part 51 in the X-axis direction. The second terminal block 52, for example, includes a main body part 520, a raised insulation part 521, notches 522a and 522b, lower projection parts 523a and 523b, stoppers 524a and 524b.

The main body part 520 is a flush with the core installation face 411 of the first tubular part accommodated in the second tubular part 51 (see FIG. 3). A length of the main body part 520 along the Y-axis direction is longer than a length of the second tubular part 51 along the Y-axis.

The raised insulation part 521 is formed at the outer end in the X-axis direction of the main body part 520, and the raised insulation part 521 projects upward from the upper surface of the main body 520. As shown in FIG. 1A, the raised insulation part 521 is positioned, in the X-axis direction, between the wire joint parts 31c and 31d and the first core 70. By separating the first core 70 and the wire joint parts 31c and 31d using the raised insulation part 521, the insulation distance (the creepage distance and the space distance) between these is extended.

The raised insulation part 521 is formed at a position higher than the wire joint parts 31c and 31d. A height of the raised insulation part 521 may be the same as or thicker than a thickness of the first core 70 in the Z-axis direction. Also, a length of the raised insulation part 521 along the Y-axis is the same as or longer than the length of the first core 70 along the Y-axis. Thereby, the insulation distance between the first core 70 and the wire joint parts 31c and 31d can be extended effectively.

As shown in FIG. 5A, the notches 522a and 522b are formed at the upper part of the raised insulation part 521. The notches 522a and 522b are formed respectively at one end and the other end of the raised insulation part 521 in the Y-axis direction. The stoppers 524a and 524b are formed at the center area in the Y-axis direction of the main body part 520, and the stoppers 524a and 524b project upward from the upper surface of the main body part 520. The stoppers 524a and 524b are spaced apart along the Y-axis, and project from the inner surface of the raised insulation part 521.

As shown in FIG. 1A, the stoppers 524a and 524b are positioned, in the X-axis direction, between the raised insulation part 521 and the end part of the first core 70 in the X-axis direction. The stoppers 524a and 524b contact with the end part of the first core 70 in the X-axis direction, and the position of the first core 70 in the X-axis direction is determined. Note that, the number of stoppers 524a and 524b is not particularly limited, and only one stopper may be used.

As shown in FIG. 5A, the lower projection parts 523a and 523b project downward from the bottom face of the main body part 520. The lower projection parts 523a and 523b are arranged by taking space between each other along the Y-axis. The lower projection part 523a is provided with the external connection part 32c, and the lower projection part 523b is provided with the external connection part 32b.

The terminals 30c and 30d are arranged apart from each other along the Y-axis. The terminals 30c and 30d are integrally molded (insert molded) respectively with the lower projection parts 523a and 523b. Note that, the terminals 30c and 30d may be respectively inserted in the lower projection parts 523a and 523b. The wire joint part 31c projects out along the X-axis from the lower projection part 523a. The external connection part 32c projects downward from the lower projection part 523a. The wire joint part 31d projects out along the X-axis from the lower projection part 523b. The external connection part 32d projects downward from the lower projection part 523b.

The side wall parts 53a and 53b are arranged apart from each other along the Y-axis. The side wall parts 53a and 53b project upward from the upper surface of the main body part 520. As shown in FIG. 1A, the end part in the X-axis direction of the first core 70 is arranged between the side wall part 53a and the side wall part 53b. The side wall parts 53a and 53b hold the end part in the X-axis direction of the first core 70 from the both sides in the Y-axis direction of the first core 70. The side wall parts 53a and 53b prevent the position of the first core 70 from shifting in the Y-axis direction.

The end part in the X-axis direction of the first core 70 is connected to the side wall parts 53a and 53b using the resin 110. Also, the end part in the X-axis direction of the first core 70 is connected to the upper face of the main body part 520 at the position further outside than the position of the joining part 120 along the X-axis direction (FIG. 3). The upper part of the side wall parts 53a and 53b has notches to increase the adhesive strength (adhered area) with the resin 110.

As shown in FIG. 5C, the guide protrusions 58a and 58b project downward from the bottom of the second bobbin 50. The guide protrusions 58a and 58b are arranged apart from each other along the Y-axis direction. Also, the guide protrusions 58a and 58b extend in a longitudinal form along the X-axis direction. The lead-out paths 59a and 59b are respectively formed along the guide protrusions 58a and 58b, and the guide protrusions 58a and 58b extend along the X-axis direction. As shown in FIG. 6, the second lead-out part 22a is pulled out along the lead-put path 59a to the wire joint part 31c from the second wound part 21. Also, the second lead-out part 22b is pulled out along the lead-out path 59b to the wire joint part 31d from the second wound part 21.

A part of the lead-out path 59a is formed between the guide protrusion 58a and the lower projection part 523a. By pulling out the second lead-out part 22a along the lead-out path 59a, the guide protrusion 58a and the lower projection part 523a can protect the second lead-out part 22a from external load. Also, a part of the lead-out path 59b is formed between the guide protrusion 58b and the lower projection part 523b. By pulling out the second lead-out part 22b along the lead-out path 59b, the guide protrusion 58b and the lower projection part 523b can protect the second lead-out part 22b from external load.

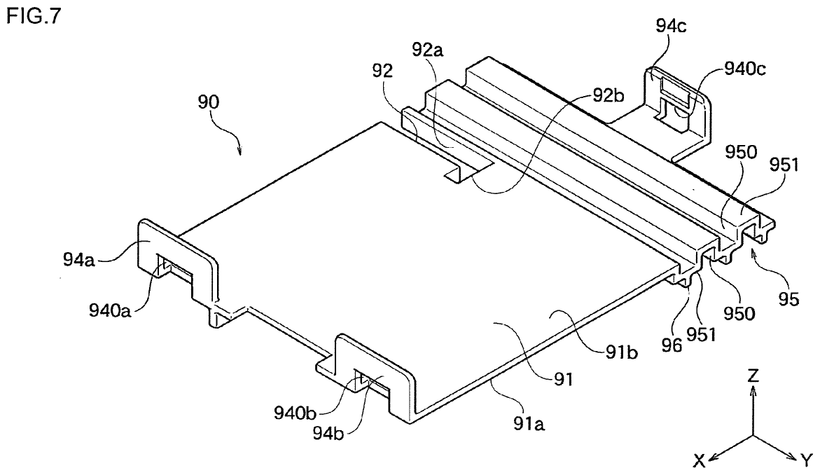

As shown in FIG. 5B, the side projection part 60 projects out along the X-axis from the end part in the X-axis direction of the intermediate part 56. The side projection part 60 is formed on the base part 560 of the intermediate part 56 described in below. At the side projection part 60, the engaging projection 543c is formed. The engaging projections 543a to 543c shown in FIG. 5C engage with the engaging holes 940a to 940c of the first cover 90 shown in FIG. 7.

The intermediate part 56 is integrally formed to the second tubular part 51, and it is positioned to the opposite side of the second terminal block 52. As shown in FIG. 1A, while under the condition that the first bobbin 40 and the second bobbin 50 are combined, the intermediate part 56 is positioned between the second tubular part 51 (or the second wound part 21) and the first terminal block 42. The intermediate part 56 is adjacent to the second wound part 21, and also adjacent to the lower projection parts 423a and 423b of the first terminal block 42. As shown in FIG. 5B, the intermediate part 56 has a U-like shape, and includes the base part 560 and a pair of side parts 561.

The base part 560 is formed continuous with the base part of the second tubular part 51. The base part 560 projects out along the X-axis from the end part in the X-axis direction of the second tubular part 51. The pair of side parts 561 is formed so that these are continuous with the side parts of the second tubular part 51. One of the pair of side parts 561 projects upward from the base part 560 so that it is perpendicular to the base part 560 at the end in the Y-axis direction of the base part 560. The other one of the pair of side parts 561 projects upwards from the base part 560 so that it is perpendicular to the base part 560 at the other end in the Y-axis direction of the base part 560.

As shown in FIG. 5B and FIG. 5C, the corrugation 57 is formed on the outer surface of the intermediate part 56, that is, on the outer surface of the base part 560 and the outer surface of the side part 561. The corrugation 57 extends in a U-like shape along the outer surface of the intermediate part 56. The corrugation 57 is formed from the position adjacent to the wound part 21 (FIG. 1A) to the position adjacent to the lower projection parts 423a and 423b of the first terminal block 42.

The corrugation 57 includes a groove 570 and a ridge 571. The groove 570 and the ridge 571 are formed continuously from the base part 560 to one of the side parts 561. Also, the groove 570 and the ridge 571 are formed continuously from the base part 560 to the other one of the side parts 561.

The corrugation 57 includes a plurality of grooves 570 (in the present embodiment, two grooves) and a plurality of ridges 571 (in the present embodiment, three ridges). Note that, the number of grooves 570 is not particularly limited, and it may be one, or three or more. Also, the number of ridges 571 is not particularly limited, and it may be two, or four or more.

A width in the X-axis of each of the two grooves 570 is the same; however, the width may be different. Also, a width in X-axis of each of three ridges 571 is the same, however, the width may be different. The three ridges 571 are equally spaced apart between each other, however, the space between each other may be different. A width along the X-axis of the groove 570 is wider than the width along the X-axis of the ridge 571, however, it may be the same or smaller than the width along the X-axis of the ridge 571.

In the base part 560, the groove 570 and the ridge 571 extend in a direction perpendicular to the axis direction (Y-axis direction) of the second tubular part 51. The groove 570 and the ridge 571 extend continuously along the Y-axis from one end to the other end of the Y-axis direction of the base part 560 in the Y-axis direction. The groove 570 and the ridge 571 extend linearly along the Y-axis, however, these may be bent or curved. Also, the groove 570 and the ridge 571 may extend diagonally to the Y-axis.

By forming the corrugation 57 on the base part 560, the creepage distance between the wire joint part 31a (the first lead-out part 12a connected to the wire joint part 31a) and the second wound part 21 can be extended, and the creepage distance between the wire joint part 31b (the first lead-out part 12b connected to the wire joint part 31b) and the second wound part 21 can be extended.

In the side part 561, the groove 570 and the ridge 571 extend in a direction (Z-axis direction) perpendicular to an axial direction of the second tubular part 51. The groove 570 and the ridge 571 extend linearly along the Z-axis, however, these may be bent or curved. Also, the groove 570 and the ridge 571 may extend diagonally to the Z-axis.

As shown in FIG. 1A, the groove 570 and the ridge 571 extend, along the Z-axis, from the lower end of the side part 561 to the position higher than the first terminal block 42 (more specifically, the upper surface of the main body part 420). Note that, the groove 570 and the ridge 571 may, for example, extend from the lower end of the side part 561 to the same position of the first terminal block 42 (more specifically, the upper surface of the main body part 420). Alternatively, the groove 570 and the ridge 571 may, for example, extend from the lower end to the upper end of the side part 561 along the Z-axis.

By forming the corrugation 57, the creepage distance between the wire joint part 31a (the lead-out part 12a connected to the wire joint part 31a) and the second wound part 21 can be extended, and also the creepage distance between the wire joint part 31b (the lead-out part 12b connected to the wire joint part 31b) and the second wound part 21 can be extended.

As shown in FIG. 6, the first tubular part 41 of the first bobbin 40 is inserted in the second tubular part 51 of the second bobbin 50 in a direction indicated by an arrow. As shown in FIG. 3, the first tubular part 41, where the first core 70 is accommodated in the through hole 410, is accommodated in a through hole 510. The end part of the second tubular part 51 in the X-axis positive direction contacts the lower projection parts 423a and 423b; and, with respect to the X-axis direction, the position of the end part of the second tubular part 51 is set by the lower projection parts 423a and 423b. The first core 70 is arranged over the upper surface of the main body part 420 of the first terminal block 42, the core installation face 411, and the upper surface of the main body part 520 of the second terminal block 52.

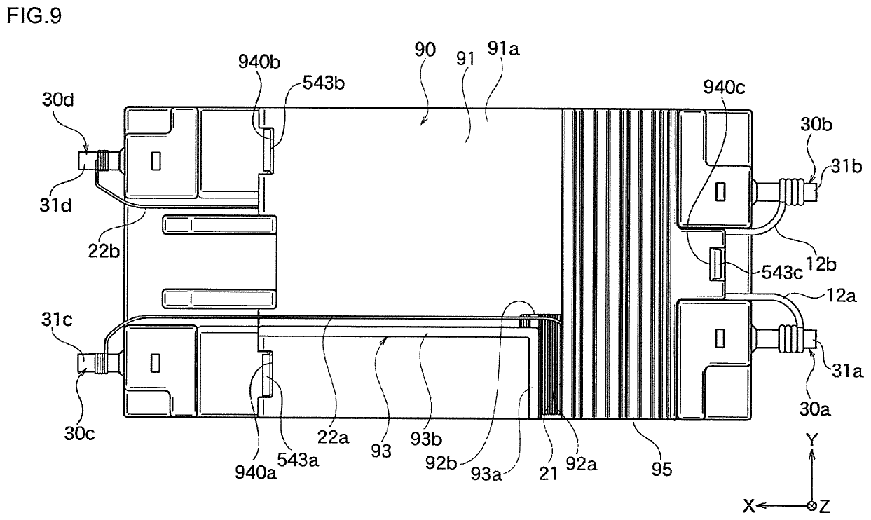

As shown in FIG. 1A and FIG. 1B, the first cover 90 is installed on the base part of the second bobbin 50. As shown in FIG. 7, the first cover 90 includes a cover corrugation 95. The first cover 90 includes a cover main body 91, a slit 92, a guide part 93 (FIG. 9), engaging parts 94a to 94c, and a projection part 96. However, the first cover 90 may not include at least one of these members. The first cover 90 is, for example, configured of the same material used for the first bobbin 40 (FIG. 4).

The cover main body 91 is configured of a tabular body having a flat shape. The cover main body 91 covers the second wound part 21 (FIG. 1A) from below. The cover main body 91 includes an outer surface 91a and an inner surface 91b. The outer surface 91a is a surface positioned opposite to the second tubular part 51 (FIG. 5A), and the inner surface 91b is a surface positioned on the same side as the second tubular part 51.

As shown in FIG. 9, the cover main body 91 is arranged between the second wound part 21 and the second lead-out part 22a. The cover main body 91 separates the second wound part 21 and the second lead-out part 22a, thereby, the insulation distance (the creepage distance and the space distance) between these can be extended. As shown in FIG. 3, the cover main body 91 contacts the partition parts 55a to 55f of the second bobbin 50.

As shown in FIG. 7, the slit 92 is formed so as to penetrate through the outer surface 91a and the inner surface 91b of the cover main body 91. The slit 92 is bent in a L-like shape, and includes a first portion 92a and a second portion 92b. The first portion 92a extends from the end part towards the inner side in the Y-axis direction of the cover main body 91. The second portion 92b is perpendicular to the first portion 92a and extends along the X-axis.

As shown in FIG. 9, the second lead-out part 22a is pulled out from the second wound part 21 through the slit 92 to outside of the cover main body 91. More specifically, the second lead-out part 22a is guided from the end part in the Y-axis direction side to the inner side of the cover main body 91 through the first portion 92a. Then, the second lead-out part 22a is guided to the wire joint part 31c through the second portion 92b.

The guide part 93 is formed on the outer surface 91a, and protrudes downward from the outer surface 91a. A height of the guide part 93 is about the same as the diameter of the second lead-out part 22a, or it may be larger or smaller than the diameter.

The guide part 93 is bent in a L-like shape, and includes a first extended part 93a and a second extended part 93b. The first extended part 93a extends along the first portion 92a of the slit 92 from the end part to the inner side in the Y-axis direction of the cover main body 91. The second extended part 93b is perpendicular to the first extended part 93a and extends along the X-axis. Part of the second extended part 93b extends along the second portion 92b of the slit 92. The guide part 93 prevents the second lead-out part 22a from shifting its position, and guides the second lead-out part 22a to the wire joint part 31c.

As shown in FIG. 7, the engaging parts 94a and 94b are formed on one end in the X-axis direction of the cover main body 91, and also the engaging parts 94a and 94b extend upwards. The engaging parts 94a and 94b are arranged apart from each other along the Y-axis. The engaging parts 94c is formed on the other end in the X-axis direction of the cover main body 91. The engaging part 94c has a L-like shape, and bends upwards.

The engaging parts 94a to 94c respectively have engaging holes 940a to 940c. As shown in FIG. 9, the engaging projections 543a to 543c of the second bobbin 50 engage with the engaging holes 940a to 940c.

The cover corrugation 95 and the cover main body 91 are formed integrally. More specifically, the cover corrugation 95 is formed, along the Y-axis, from one end to the other end of the cover main body 91 in the Y-axis direction. Also, the cover corrugation 95 is formed, along the X-axis direction, from the position adjacent to the slit 92 towards the end part in the X-axis direction of the cover main body 91. The cover corrugation 95 is formed such that it is bent in a wave-form (a S-like shape or a crank shape).

The cover corrugation 95 is formed on the outer surface 91a and the inner surface 91b of the cover main body 91. Thus, the outer surface 91a is bent in a wave-form (a S-like shape or a crank shape) due to the cover corrugation 95. Also, the inner surface 91b is also bent in a wave-form (a S-like shape or a crank shape) due to the cover corrugation 95.

The cover corrugation 95 has a plurality of grooves 950 and a plurality of ridges 951. The outer surface 91a is formed with two grooves 950 and three ridges 951. Note that, the number of grooves 950 formed on the outer surface 91a may be one, or it may be three or more. Also, the number of ridges 951 formed on the outer surface 91a may be one, two, or four or more.

The inner surface 91b is formed with three grooves 950 and two ridges 951. Note that, the number of grooves 950 formed on the inner surface 91b may be one, two, or four or more. Also, the number of ridges 951 formed on the inner surface 91b may be one, or three or more.

In the outer surface 91a, a width along the X-axis of each of two grooves 950 is the same, however, it may be different. Also, a width, along the X-axis, of each of the three ridges 951 is the same; however, it may be different. The three ridges 951 are arranged by equally spaced apart from each other; however, the distance between each of these may be different. A width, along the X-axis, of the ridge 951 may be larger than the width, along the X-axis, of the groove 950; however, the width of the ridge 951 may be the same as the width of the groove 950, or the width of the ridge 951 may be smaller than the width of the groove 950.

In the inner surface 91b, a width, along the X-axis, of each of the three grooves 950 is the same; however, it may be different. Also, the width, along the X-axis, of each of the two ridges 951 is the same; however, it may be different. The three grooves 950 are arranged by equally spaced apart from each other; however, the distance between each of these may be different. The width, along the X-axis, of the ridge 951 is larger than the width, along the X-axis, of the groove 950; however, the width of the ridge 951 may be the same as the width of the groove 950, or the width of the ridge 951 may be smaller than the width of the groove 950.

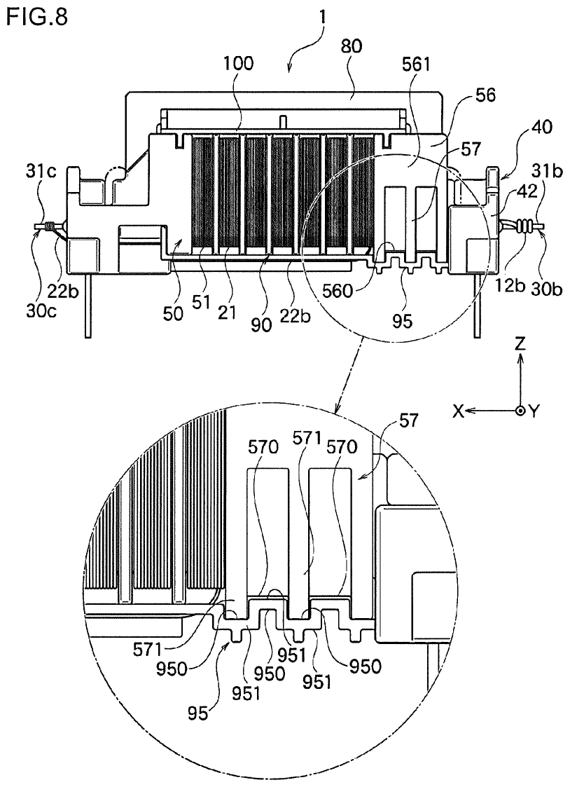

The groove 950 and the ridge 951 extend in a direction perpendicular to the axial direction of the second tubular part 51 (FIG. 8). The groove 950 and the ridge 951 extend continuously along the Y-axis from one end to the other end of the Y-axis direction of the cover main body 91. The groove 950 and the ridge 951 may extend in a straight line along the Y-axis; however, it may be bent or curved. Also, the groove 950 and the ridge 951 may extend diagonally with respect to the Y-axis.

As shown in FIG. 8, the cover corrugation 95 is formed at a position corresponding to the corrugation 57 of the second bobbin 50. The cover corrugation 95 faces the base part 560, and engages with the corrugation 57 formed on the base part 560. That is, the ridge 571 of the corrugation 57 is placed into the groove 950 of the cover corrugation 95, and thereby, the ridge 571 engages with the groove 950. Also, the ridge 950 of the cover corrugation 95 is placed into the ridge 571 of the cover corrugation 57, and thereby, the ridge 951 engages with the groover 570.

The ridge 571 and the groove 950 are in contact; however, a space may be formed between these. Also, a space is formed between the ridge 951 and the groove 570; however, these may be in contact with each other.

By forming the cover corrugation 95 to the cover main body 91, the creepage distance between the wire joint part 31a (the first lead-out part 12a connected to the wire joint part 31a) and the second wound part 21 can be extended. Further, the creepage distance and the space distance between the wire joint part 31b (the first lead-out part 12b connected to the wire joint part 31b) and the second wound part 21 can be extended.

As shown in FIG. 7, the projection part 96 is formed on the ridge 951, and projects downward from the outer surface 91a. The projection part 96 extends from one end to the other end along the Y-axis of the ridge 951. A width of the projection part 96 along the X-axis is smaller than the width of the projection part 951 along the X-axis. The three ridges 951 formed on the outer surface 91a are respectively formed with the three projection parts 96. Among these projection parts 96, at least one may be omitted from the first cover 90.

As shown in FIG. 10, the second cover 100 includes, for example, a cover main body 101, engaging projections 102a and 102b, core limiting parts 103a and 103b, side projections 104a and 104b, engaging parts 105a and 105b, and engaging holes 106a and 106b. Although it is not particularly limited, the second cover 100 may be configured of the same material as the first cover 90.

The cover main body 101 is configured of a tabular body having a flat shape. The cover main body 101 includes an outer surface 101a and an inner surface 101b. The outer surface 101a is a surface positioned opposite to the second tubular part 51 (FIG. 5A), and the inner surface 101b is a surface positioned on the same side used for the second tubular part 51.

As shown in FIG. 1B, the cover main body 101 covers the second tubular part 51 from above. The cover main body 101 is arranged between the second wound part 21 and the main body part 81 of the second core 80. The cover main body 101 separates the second wound part 21 and the main body part 81, thereby, the insulation distance (the creepage distance and the space distance) between the second wound part 21 and the main body part 81 is extended. As shown in FIG. 3, the cover main body 101 contacts the partition parts 55a to 55f of the second bobbin 50.

As shown in FIG. 10, the engaging projections 102a and 102b project downward from the inner surface 101b. The engagement projection 102a is positioned at one end in the X-axis direction of the cover main body 101, and the engagement projection 102b is positioned at the other end in the X-axis direction of the cover main body 101. The engagement projections 102a and 102b extend from one end to the other end of the inner surface 101b in the Y-axis direction.

The core limiting parts 103a and 103b project upward from the outer surface 101a. The core limiting part 103a is positioned at one side in the Y-axis direction of the cover main body 101, and the core limiting part 103b is positioned at the other side in the Y-axis direction of the cover main body 101. The core limiting parts 103a and 103b extend from one end to the other end in the X-axis direction of the outer surface 101a. As shown in FIG. 1B, the second core 80 is arranged between the core limiting part 103a and the core limiting part 103b. Therefore, the core limiting parts 103a and 103b can prevent the position shifting of the second core 80 in the Y-axis direction.

As shown in FIG. 10, a plurality of side projections 104a (in the present embodiment, three side projections 104a) is formed on the outer surface 101a, and these side projections are arranged apart from each other in the Y-axis direction. The side projections 104a project outward in the Y-axis direction from the core limiting part 103a. Also, a plurality of side projections 104b (in the present embodiment, three side projections 104b) is formed on the outer surface 101a, and these are arranged apart from each other along the Y-axis. The side projection 104b projects outward from the core limiting part 103b along the Y-axis. By forming the side projections 104a and 104b on the cover main body 101, the strength of the cover main body 101 can be enhanced.

The engaging part 105a is formed at one end of the cover main body 101 in the X-axis direction, and it projects downward. The engaging part 105b is formed at the other end of the cover main body 101 in the X-axis direction, and it projects downward. The engaging parts 105a and 105b are respectively formed with the engaging holes 106a and 106b. The engaging hole 106a engages with the engaging projection 542a shown in FIG. 5A, and the engaging hole 106b engages with the engaging projection 542b shown in FIG. 5B (see FIG. 1B).

Next, a method for producing the coil device 1 is described. First, each member shown in FIG. 2 is prepared. The terminals 30a and 30b (FIG. 1B) are installed to the first terminal block 42 of the first bobbin 40, for example, an insert molding. Similarly, terminals 30c and 30d are installed to the second terminal block 52 of the second bobbin 50.

Next, the first wire 10 is wound around the first tubular part 41 to form the first wound part 11. As shown in FIG. 6, the first lead-out parts 12a and 12b are pulled out from the bottom face of the first tubular part 41, and respectively connects to the wire joint parts 31a and 31b.

Also, the second wire 20 is wound around the second tubular part 51 to form the second wound part 21. Next, as shown in FIG. 9, the first cover 90 is installed on the second bobbin 50. Next, as shown in FIG. 9, the second lead-out part 22a passes through the slit 92 (the first portion 92a and the second portion 92b) of the first cover 90 and is pulled out towards the wire joint part 31c from the bottom face side of the second tubular part 50; thereby, the second lead-out part 22a and the wire joint part 31c are connected. Also, as shown in FIG. 6, the second lead-out part 22b is pulled out from the second wound part 21 towards the wire joint part 31b, and the second lead-out part 22b and the wire joint part 31b are connected.

Next, the first core 70 is inserted in the through hole 410 of the first tubular part 41 shown in FIG. 2. Next, the first tubular part 41, to which the first core 70 is inserted, is inserted in the through hole 510 of the second tubular part 51 in the direction indicated by an arrow shown in FIG. 6.

Next, as shown in FIG. 1B, the second cover 100 is installed on the second bobbin 50. Then, the second cover 80 is installed over the second cover 100. Next, as shown in FIG. 3, the leg part 82 of the second core 80 contacts the surface of the first core 70 at the joining part 120.

Next, as shown in FIG. 1A, the resin 110 is adhered on the end part at the X-axis positive direction side of the first core 70. Then, using the resin 110, the end part of the first core 70 at the X-axis positive direction side is connected to the led part 82 of the second core 80, the side wall parts 53a and 53b, and the upper surface of the main body part 520 (FIG. 5A).

Similarly, as shown in FIG. 1B, the resin 110 is adhered on the end part of the first core 70 in the X-axis negative direction. Then, the end part of the first core 70 in the X-axis negative direction connects, via the resin 110, to the leg part 82 of the second core 80, the side wall parts 43a and 43b, and the upper surface of the main body part 420 (FIG. 4). Next, as shown in FIG. 1A, the second bobbin 50, the first cover 90, the second core 80, etc., are fixed using the tape 130. The tape 130 is an insulation tape made by plastics, rubber, etc. The tape 130 is used for fixing the second bobbin 50, the first core 90, the second core 80, etc., so that the assembled structure of these do not disassemble. As discussed hereinabove, the coil device 1 can be produced.

As shown in FIG. 2, the coil device 1 of the present embodiment includes the first bobbin 40 and the second bobbin 50, and the first tubular part 41 is accommodated inside the second tubular part 51. That is, as shown in FIG. 3, the first tubular part 41 and the second tubular part 51 are arranged such that these overlap with each other. Thus, compared to a conventional technology, the length of the coil device 1 in the axis direction (the X-axis direction) of the first tubular part 41 becomes shorter; hence, it is possible to achieve a compact coil device 1.

Also, as shown in FIG. 1A, the intermediate part 56 is positioned between the second tubular part 51 and the first terminal block 42, and the corrugation 57 is formed on the outer surface of the intermediate part 51. Therefore, depending on the level of corrugation 57, the creepage distance between the second wound part 21 provided on the second tubular part 21, and the terminals 30a and 30b (the first lead-out part 12a connected to the terminal 30a and the first lead-out part 12b connected to the terminal 30b) provided on the first terminal block 42 is extended; thus, the insulation property between the second wound part 21 and the terminals 30a and 30b can be secured. Therefore, according to the present embodiment, a compact coil device 1 can be achieved and a compact coil device 1 with excellent voltage reliability can be achieved without decreasing the voltage resistance between the second wound part 21 and the terminals 30a and 30b.

Also, as shown in FIG. 5B, the groove 570 and the ridge 571 extend in a direction (the Y-axis direction or the Z-axis direction) perpendicular to the axis direction of the second tubular part 51. Therefore, depending on the number of repeats of groove 570 and ridge 571, the creepage distance between the second wound part 21 (FIG. 1B) provided on the second tubular part 51 and the terminals 30a and 30b (FIG. 1B) provided on the first terminal block 42 can be extended,

Also, the corrugation 57 is at least formed on the side part 561. Therefore, the second wound part 21 (FIG. 1B) provided on the second tubular part 51 and the terminals 30a and 30b provided on the first terminal block 42 can be extended, and this prevents an electric current path via the side part 561 from forming between the second wound part 21 and the terminals 30a and 30b.

Also, the corrugation 57 is at least formed on the base part 560. Therefore, at the base part 560, the second wound part 21 (FIG. 1B) provided on the second tubular part 51 and the terminals 30a and 30b provided on the first terminal block 42 can be extended, and this prevents an electric current path via the side part 561 from forming between the second wound part 21 and the terminals 30a and 30b.

Also, the corrugation 57 is formed continuous from the base part 560 to the side part 561. Therefore, at the base part 560 and the side part 561, the creepage distance between the second wound part 21 (FIG. 1B) provided on the second tubular part 51 and the terminals 30a and 30b (FIG. 1B) provided on the first terminal block 42 is extended, and this allows to prevent an electric current path via the base part 560 and the side part 561 from forming between the second tubular part 21 and the terminals 30a and 30b.

Also, as shown in FIG. 7, at the first cover 90, the cover corrugation 95 is formed, and the cover corrugation 95 is at the position corresponding to the corrugation 57. Therefore, as shown in FIG. 9, depending on the level of cover corrugation 95, the creepage distance between the second lead-out part 22a extending on the first cover 90 and the terminals 30a and 30b provided on the first terminal block 42 can be extended. Thereby, an electric current path via the second cover 100 is prevented from forming between the second lead-out part 22a and the terminals 30a and 30b, and thus, the insulation property between the second lead-out part 22a and the terminals 30a and 30b can be ensured.

Also, as shown in FIG. 8, the cover corrugation 95 engages with the corrugation 57. Thus, depending on the level of corrugation 57 and the level of cover corrugation 95, the space distance between the second wound part 21 provided on the second tubular part 51 and the terminals 30a and 30b provided on the first terminal block 42 is extended. Therefore, an electric current path through a space between the second wound part 21 and the terminals 30a and 30b, and a space between the second bobbin 50 and the first cover 90 can be prevented from forming; thus, the insulation property between these can be secured.

Also, the cover corrugation 95 is formed on the outer surface 91a and the inner surface 91b of the first cover 90. Therefore, as shown in FIG. 9, the creepage distance between the second lead-out part 22b extending on the first cover 90 and the terminals 30a and 30b provided on the first terminal block 42 can be extended due to the cover corrugation 95 formed on the outer surface 91a. Furthermore, the space distance between the second wound part 21 provided on the second tubular part 51 and the terminals 30a and 30b provided on the first terminal block 42 can be extended due to the cover corrugation 95 formed on the inner surface 91b of the first cover 90.

Note that, the present disclosure is not limited to the above-mentioned embodiments, and various modifications within the scope of the present disclosure are possible.

In the above-mentioned embodiment, an example which uses the present disclosure as a transformer was explained, however, the present disclosure may be applied to a coil device other than a transformer.

In the above-mentioned embodiment, an I-type core may be combined to configure the second core 80 (FIG. 2).

In the above-mentioned embodiment, the corrugation 57 has a plurality of grooves 570; however, the number of grooves may be one. Also, the corrugation 57 has a plurality of ridges 571, however, the number of ridges may be one. Also, the cover corrugation 95 includes a plurality of ridges 950, however, the number of grooves may be one. Also, the cover corrugation 95 includes a plurality of ridges 951, however, the number of ridges may be one.

### REFERENCE SIGNS LIST

1 . . . Coil device
10 . . . First wire
11 . . . First wound part
12a, 12b . . . First lead-out part
20 . . . Second wire
21 . . . Second wound part
22a, 22b . . . Second lead-out part
30a to 30s . . . Terminal
31a to 31d . . . Wire joint part
32a to 32d . . . External connection parts
40 . . . First bobbin
41 . . . First tubular part
410 . . . Through hole
411 . . . Core installation surface
42 . . . First terminal block
420 . . . Main body part
421 . . . Raised insulation part
422a, 422b . . . Notch
423a, 423b . . . Lower projection part
424 . . . Stopper
43a, 43b . . . Side wall part
44a, 44b . . . Flange part
45a to 45c . . . Partition parts
46 . . . Guide protrusion
47a, 47b . . . Lead-out path
50 . . . Second bobbin
51 . . . Second tubular part
510 . . . Through hole
52 . . . Second terminal block
520 . . . Main body part
521 . . . Raised insulation part
522a, 522b . . . Notch
523a, 523b . . . Lower projection part
524a, 524b . . . Stopper
53a, 53b . . . Side wall part
54a, 54b . . . Flange part
540a, 540b . . . Engaging groove
541a Flange side wall part
542a,542b,543a, 543b,543c . . . Engaging projection
55a to 55f . . . Partition part
56 . . . Intermediate part
560 . . . Base part
561 . . . Side part
57 . . . Corrugation
570 . . . Groove
571 . . . Ridge
58a, 58b . . . Guide protrusion
59a, 59b . . . Lead-out path
60 . . . Side projection part
70 . . . First core
80 . . . Second core
81 . . . Main body part
82 . . . Leg part
90 . . . First cover
91 . . . Cover main body
91a . . . Outer surface
91b . . . Inner surface
92 . . . Slit
92a . . . First portion
92b . . . Second portion
93 . . . Guide part
93a . . . First extended part
93b . . . Second extended part
94a to 94c . . . Engaging part
940a to 940c . . . Engaging hole
95 . . . Cover corrugation
950 . . . Groove
951 . . . Ridge
96 . . . Projection part
100 . . . Second cover
101 . . . Cover main body
101a . . . Outer surface
101b . . . Inner surface
102a, 102b . . . Engaging projection
103a, 103b . . . Core liming part
104a, 104b . . . Side projection
105a, 105b . . . Engaging part
106a, 106b . . . Engaging hole
110 . . . Resin
120 . . . Joining part
130 . . . Tape

What is claimed is:

1. A coil device, comprising:
a first bobbin including a first tubular part and a terminal block provided with a terminal;
a first wire including a first wound part provided on the first tubular part, and a first lead-out part pulled out from the first wound part to connect with the terminal;
a second bobbin including a second tubular part accommodating the first tubular part, and an intermediate part positioned between the second tubular part and the terminal block; and
a second wire including a second wound part provided on the second tubular part, and a second lead-out part pulled out from the second wound part to an opposite side of the first lead out part; wherein
the intermediate part has a corrugation on an outer surface of the intermediate part.

2. The coil device according to claim 1, wherein a groove and a ridge configuring the corrugation formed on the intermediate part extend in a direction perpendicular to an axis direction of the second tubular part.

3. The coil device according to claim 1, wherein the intermediate part comprises a base part and a side part extending vertically from the base part, and
the corrugation is formed at least on the side part.

4. The coil device according to claim 1, wherein the intermediate part comprises a base part and a side part extending vertically from the base part, and
the corrugation is formed at least on the base part.

5. The coil device according to claim 1, wherein the intermediate part comprises a base part and a side part extending vertically from the base part, and
the corrugation is formed in a continuous manner from the base part to the side part.

6. The coil device according to claim 1, further comprising:
a cover installed on a bottom of the second bobbin and arranged between the second wound part and the second lead-out part; wherein
the cover is formed with a cover corrugation, and
the cover corrugation on the cover is at a position corresponding to the corrugation of the intermediate part.

7. The coil device according to claim 6, wherein the cover corrugation engages with the corrugation of the intermediate part.

8. The coil device according to claim 6, wherein the cover corrugation is formed on an outer surface and an inner surface of the cover.
